(19) United States
(12) Patent Application Publication
(10) Pub. No.: US 2008/0140519 A1
(43) Pub. Date: Jun. 12, 2008

(54) ADVERTISING BASED ON SIMPLIFIED INPUT EXPANSION

(75) Inventors: Bo Thiesson, Woodinville, WA (US); Christopher A. Meek, Kirkland, WA (US); Kenneth W. Church, Seattle, WA (US); Timothy D. Sharpe, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/608,631

(22) Filed: Dec. 8, 2006

(51) Int. Cl. G06Q 30/00; G06F 7/06; G06F 17/30

(52) U.S. Cl. 705/14; 707/5; 707/E17.017

(57) ABSTRACT

Match criteria are provided to specify when advertisements will be shown, for instance in a search environment. Input such as search queries can be represented in a simplified form such as an implicit and/or explicit wildcard expression. Advertisers or other entities can bid on terms such that advertisements or similar content are presented when the terms match an expansion of a simplified input. Matching ads can subsequently be displayed alone or in combination with query expansion suggestions and/or query results.

### CROSS-REFERENCE TO RELATED APPLICATIONS

This application is related to co-pending U.S. patent application Ser. No. 11/159,711, filed Jun. 23, 2005, entitled, “USING LANGUAGE MODELS TO EXPAND WILDCARDS,” U.S. patent application Ser. No. 11/332,954, filed Jan. 17, 2006, entitled “MULTI-WORD WORD WHEELING,” and U.S. patent application Ser. No. 11/333,486, filed Jan. 17, 2006, entitled “SERVER SIDE SEARCH WITH MULTI-WORD WORD WHEELING AND WILDCARD EXPANSION.” The entireties of these applications are incorporated herein by reference.

### BACKGROUND

The Internet and the World Wide Web continue to expand rapidly with respect to both volume of information and number of users. The Internet is a collection of interconnected computer networks. The World Wide Web, or simply the web, is a service that connects numerous Internet accessible sites via hyperlinks and Uniform Resource Locators (URLs). As a whole the web, provides a global space for accumulation, exchange and dissemination of all types of information.

The increase in usage is largely driven by the ever-growing amount of available information pertinent to user needs. By way of example, the web and Internet was initially utilized solely by researches to exchange information. At present, people utilize the web to mange bank accounts, complete taxes, view product information, sell and purchase products, download music, take classes, research topics, and find directions, among other things. Usage will continue to flourish as additional relevant information becomes available over the web.

To maximize likelihood of locating relevant information amongst an abundance of data, search engines are often employed over the web. A web search engine, or simply a search engine, is a tool that facilitates web navigation based on entry of a search query comprising one or more keywords. Upon receipt of a query, the search engine retrieves a list of websites, typically ranked based on relevance to the query. A user can thereafter scroll through a plurality of returned sites and navigate to a site of interest.

In addition to query results, search engines return advertisements, which provide a stream of revenue to a search engine company. In particular, search engines typically show one or more advertisements (e.g., logos, text ads, graphics . . . ) on a search results page above and/or beside query results. Search engines make money by receiving bids to show advertisements on a search result page, if the match criterion for the bid is satisfied. Conventional match criterion involves specified words and/or phrases, referred to as bid terms, and the input search query.

For instance, an advertiser might bid on the term “pizza” using a phrase match type, which would match any query containing “pizza” such as “hot pizza” or “mushroom pizza.” The set of advertisements that is shown and the order in which the advertisements appear is determined as a function of the set of bids that match the search query, the size of the bid and measures of performance such as advertisement click-through rate (CTR). For example, company A might bid $0.25 for a phrase match for “pizza” and company B might bid $0.20 for the same phrase match. If the CTR is equal for the two companies, the search engine might prefer to show company A's advertisement before company B's advertisement. Further, if there are more matching bids than positions some ads may not be shown at all.

Bids are typically made as cost-per-click (CPC) commitments, although other types of bids exist. That is, an advertiser bids an amount it is willing to pay each time a user selects or clicks on an advertisement displayed as a result of a search engine query and thus accesses the information associated therewith. Additionally, bid-matching criterion can be specified as a function of limited user information. For instance, a match criterion could specify a location (e.g., zip code) and advertisements will only be shown to users from that location or that designate that location for search.

Such an advertisement model is wildly popular for several reasons. First, it allows potential customers to be targeted and presented with advertisements at a time in which they are most likely to be influential, namely when a user is searching for information. Second, it generates billions of dollars for search engine companies at least a portion of which can be re-invested to research new ways to connect users with relevant information.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to advertising with respect to a simplified input. The simplified input can correspond to a shorthand notation such as that associated with an implicit and/or explicit wildcard expression. In one embodiment, input of this kind can map to one or more conventional query expressions. Advertisers or other content providers can bid to show content based at least in part on query expansions that match a simplified input, rather than solely the input itself.

In accordance with an aspect of the disclosure, an advertisement system is provided. The system expands a simplified input and matches bid terms and/or phrases to one or more expansions. Content associated with at least a subset of the matching bids is selected to be shown based on the bids, performance measures and/or context information (e.g., user demographics, history . . . ), among other things.

According to another aspect of the disclosure, a search system can incorporate the aforementioned advertising mechanism. In particular, suggested input query expansions can be provided to a user in combination with matching advertisements. Further, query results for the top suggested expansion can be supplied. If an alternate suggested expansion is selected by a user, the advertisements and/or query results can be updated accordingly based thereon.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of an advertisement system.

FIG. 2 is a block diagram of a representative advertisement component.

FIG. 3 is a block diagram of a representative expansion component.

FIG. 4 is a block diagram of a search advertisement system.

FIG. 5 is a block diagram of a search advertisement system.

FIGS. 6a-b are exemplary screenshots illustrating interaction with a search system as disclosed.

FIG. 7 illustrates an exemplary exchange of text messages for interacting with a search system as disclosed.

FIG. 8 is a block diagram of a search system.

FIG. 9 is a flow chart diagram of an advertising method.

FIG. 10 is a flow chart diagram of a search method incorporating advertising.

FIG. 11 is a flow chart diagram of a search method based on query expansions.

FIG. 12 is a flow chart diagram of method of search employing a short messaging service.

FIG. 13 is a schematic block diagram illustrating a suitable operating environment for aspects of the subject disclosure.

FIG. 14 is a schematic block diagram of a sample-computing environment.

### DETAILED DESCRIPTION

Systems and methods are provided relating to simplified input advertising. In one instance, an alternative match criterion is provided for simplified queries such as implicit and/or explicit wildcard expressions. Bids can be received to show content or advertisements, where bid terms match expansions of simplified queries. Queries can thus be received in a simplified format from which at least one query expansion is generated. Suggested queries can then be identified from expansions and advertisements or other content shown alone or in combination with the suggested queries as function of the expansions and/or suggested queries. Additional matching criteria can also be employed together with the simplified query criterion including those that employ demographic and/or other context information.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

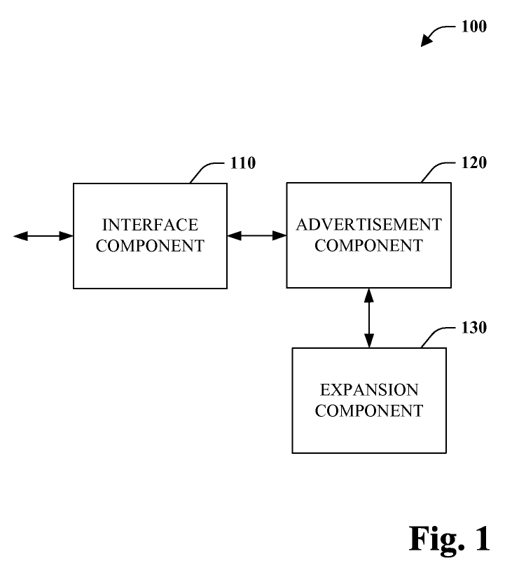

Referring initially to FIG. 1, an advertisement system 100 is illustrated in accordance with an aspect of this disclosure. The system 100 facilitates provisioning of advertisements in response to input. System 100 includes an interface component 110 operable to, among other things, receive or retrieve input and provide a response thereto.

In one embodiment, the interface component 110 can receive or receive simplified search queries. Simplified search queries can correspond to any shorthand query notation including, without limitation, implicit and/or explicit wildcard expressions. Wildcard expressions allow an expression to be provided without specifying all characters. Such an input method is sometimes referred to as word wheeling. In an explicit form, a wildcard symbol or other mechanism can be utilized to represent any combination of alphanumeric characters and/or symbols. For example, “Domino's pizza” (Domino's Pizza®) can be represented as “D* P*,” where the asterisk “*” is the wildcard. Utilizing a different wildcard, the query expression can be denoted “D? P?” or the like. Similarly, the same query can be specified simply as “D P.” Here, the wildcard is implicit after each intended word. That is, it is implicitly added and interpreted as if it read “D* P*.” Such a simplified input mechanism can be quite helpful in many situations such as where an input device has a limited keyboard (e.g., mobile device) or when a user does not know how to spell something (e.g., Arnold Schw*ger), among others.

The interface component 110 is able to interact with various types of devices. For instance, a desktop computer, a laptop, a handheld, a mobile telephone, a server, etc. can provide input data to the interface component 110. Further, the input data can include alphabetic data, numerical data (e.g., input utilizing a keypad of a mobile telephone), voice data, handwriting data or a combination thereof, inter alia. Accordingly, the interface component 110 may also provide or employ a mechanism to convert various input formats to an appropriate or standard form (e.g., to comprise alphabetic characters).

The interface component 110 is communicatively coupled to the advertisement component 120 and operable to provide or make accessible input such as simplified queries. Accordingly, the advertisement component 120 can receive the input from the interface component 110 or alternatively retrieve the input from the component 110. As mentioned, the input can be in one or more disparate formats.

The advertisement component 120 identifies at least a subset of content items associated with an input expression. Content or content items can refer to conventional advertisements and/or one or more of text, logos, images, graphics, audio and/or video. For example, a content item can include a text advertisement for a car or simply a picture of the car. Content can be linked to queries based on bid terms and/or phrases. Where a conventional query is specified such as “Dominos pizza,” an advertisement can be shown where the bid terms and/phrases match the input query terms or phrase.

Additionally, the advertisement component 120 can be employed to identify content items by matching bid terms and/or phrases to simplified input. For example, where a simplified query is specified “D* P*” bid terms that match either or both of “D*” and “P*” can be identified and content associated therewith shown. Additionally or alternatively, the advertisement component 120 can interact with the expansion component 130 to acquire a list of candidate expansions for the simplified input. For the aforementioned example, “D* P*” can be expanded to “Dominos pizza,” “drain plumber,” “domain prices” and the like. Still further yet, component 130 can identify additional related expansions such as “Dom* Pi*.” The advertisement component 120 can subsequently provide at least a subset of content items associated with bid terms and/or phrases that match the query expansion to the interface component 110 for provisioning back to an input providing entity.

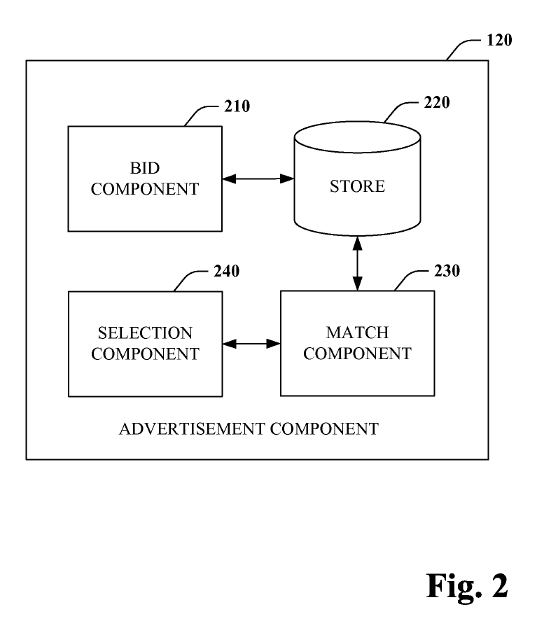

Referring to FIG. 2, an advertisement component 120 is illustrated in further detail in accordance with an aspect of the disclosure. Advertisement component 120 includes a bid component 210. The bid component 210 receives, retrieves or otherwise acquires bids on one or more terms and/or phrases as well as content (or links thereto) to be delivered. These bids specify a price an advertiser or other entity is willing to pay to show or otherwise deliver some content such as an advertisement. According to as aspect of the disclosure, bids can be acquired for simplified input expansions. For example, a bid on “pizza” is also a bid on “P*,” “P*A” or any other input that expands to “pizza.”

There are various plans that can be utilized with respect to pricing and content delivery. The most popular is cost-per-click (CPC) commitments where entities specify an amount they are willing to pay each time a user clicks on or otherwise selects a content item. Another plan is cost-per-impression (CPM) in which a entity pays an amount based on the number of times content is displayed or delivered, rather than on click through. Yet another plan is cost-per-action (CPA), which designates a cost based on an action such as a customer acquisition, sales transaction, login, sign up, etc. Other pricing plans also exist and are employable by the bid advertisement component 120 including without limitation revenue sharing and referral fees. Accordingly, there are various pricing plans that can be specified with respect to bids.

Further yet, bids can be specified on the basis of demographic features. More specifically, entities can choose to bid, not bid or include variable bids based on demographic or other context information such as user age, gender, ethnicity, marital status, location, recently searched terms and the like. For example, an advertiser might be willing to pay an additional $0.10 for a female user's click or specify that an ad is only to appear to users in particular locations. Bids may also be specified with respect to an input device (e.g., mobile device, desktop computer, kiosk . . . ).

Bid component 210 collects information pertaining to bid terms, costing schemes and context requirements, among other things, and persists such information to store 220. In addition, content items such as advertisements associated with the bids (or links thereto) can also be saved to the store 220. In accordance with one embodiment, the store 220 can be a database embodied on non-volatile computer readable medium. The bid information can be stored in a manner that facilitates expeditious matching by match component 230.

The match component 230 receives or retrieves bid information from the store 220 to enable matching with input queries. More specifically, the match component 230 matches bid terms and/or phrases to input including query expansions provided by the expansion component 130 of FIG. 1. Further yet, the match component 230 can receive or retrieve contextual information such as user demographics from a user or third party and employ such information in matching bids specified as a function of such information. For example, a user may reveal profile information such as location through interface component 110. Additionally or alternatively, the interface component 110 can automatically collect or determine information such as the type of input device utilized. This information can then be employed to match queries to bid terms and/or conditions associated with a particular location.

The selection component 240 is communicatively coupled to the match component 230 to enable communication of matching bid information to the selection component 240. The selection component 240 can thus interact with the match component 230 to identify and provide advertisements for delivery. Selection can be a function of at least one of number of advertisements to be delivered, space, relevance and revenue, among other things. Further yet, the positioning of such advertisements can be based on priority as determined by one or more of the aforementioned facts. For example, if only two bids match and are of equal value (e.g., $0.10) per click, then the bid with the higher click through rate would take priority to optimize revenue. Moreover, the selection component 240 can scale the value of a bid according to how far it is from the actual input query. For example, a determination can be made as to how many characters are needed to be added to a simplified query to match a bid term and/or phrase. Such a determination can provide some value with respect to relevance, as expansions in excess of a threshold value of change can be identified as less relevant than expansions less than or equal to the threshold or vice versa.

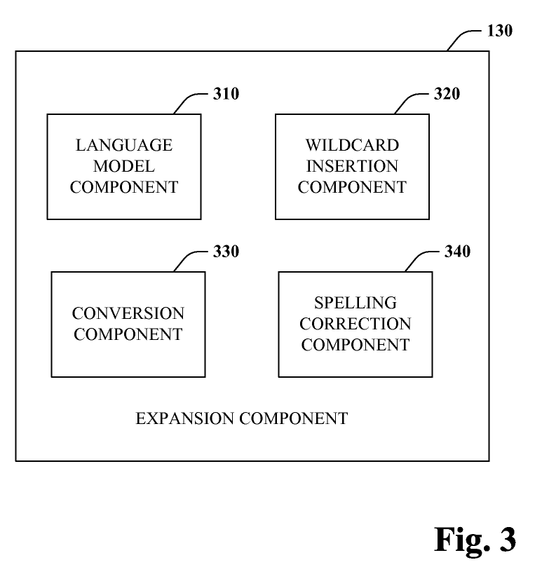

With reference to FIG. 3, illustrated is a representative expansion component 130 to expand simplified input. The expansion component 130 can include language model component 310, wildcard insertion component 320, conversion component 330 and spelling correction component 340.

The language model component 310 enables employment of a language model that provides likely expansions of wildcards associated with the input data. Thus, by utilizing the language model, the expansion component 130 can expand explicit wildcards associated with the input data to generate a candidate list of expanded data. The language model component 310 can employ any language model. For instance, a trigram language model can be utilized. Additionally, restricted language models can be employed. By way of example, a language model utilized for web queries can be based on a list of queries and probabilities associated therewith. According to another example, a language model built upon syllabic elements can be employed in connection with expanding the implicit and/or explicit wildcard(s). Pursuant to a further example, a language model utilized by the language model component 310 can be frequently updated to enable timely identification of breaking news stories.

The expansion component 130 can additionally comprise a wildcard insertion component 320 that can insert one or more implicit wildcards into input data. It is to be appreciated that the wildcard insertion component 320 can position implicit wildcards anywhere in the input data. Subsequent to the insertion of the implicit wildcards, the implicit wildcards as well as any explicit wildcards in the input data can be expanded based on the language model.

According to an example, the wildcard insertion component 320 can identify an end of an intended word within the input data. Pursuant to this example, the wildcard insertion component 320 can insert a wildcard at this identified location. It is to be appreciated that a number of such locations can be determined and therefore any suitable number of implicit wildcards can be included with the input data. By way of illustration, the wildcard insertion component 320 can locate the ends of intended words by identifying spaces and insert an implicit wildcard before each of the spaces within the input data. Additionally or alternatively, the wildcard insertion component 320 can place an implicit wildcard at the end of the input data.

The conversion component 330 converts the input data that is received in various formats to corresponding alphabetic character data. The alphabetic character data can thereafter be expanded to yield the candidate list of expanded data. Additionally or alternatively, the conversion component 330 can operate upon the data subsequent to the completion of the wildcards by the expansion component 130; however, the claimed subject matter is not so limited. By way of example, the input query that is received can be numerical data that can be entered via employing a mobile telephone. The conversion component 330 can recognize that the data received was generated with the mobile phone and convert the data to corresponding alphabetic character data. The conversion component 330 can differentiate between input data that purposefully includes numerical characters (e.g., if an input is, for instance, “T1”) and input data where the numerical characters represent alphabetic characters (e.g., which can be the case when input data is generated utilizing a cellular telephone). Pursuant to another illustration, the conversion component 330 can identify the receipt of voice data and enable speech recognition to be performed. According to a further example, the conversion component 330 can determine that a handwritten input has been obtained and conduct handwriting recognition to alter the input data.

The expansion component 130 can also include a spelling correction component 340. The spelling correction component 340 can modify a portion or the entirety of the input data to account for a potentially spelling error. Thus, at least one of the completions of the wildcard(s) in the candidate list can be associated with the modified input data. Thus, by way of example, if the input data is “mon search,” the spelling correction component 340 can provide for “msn search” in the candidate list.

It should be noted and appreciated that FIG. 3 provides only a single representative expansion component 130. Further information, regarding how expansions are generated can be located in the related applications incorporated herein by reference. These and other mechanisms are to be deemed within the scope of the subject claims.

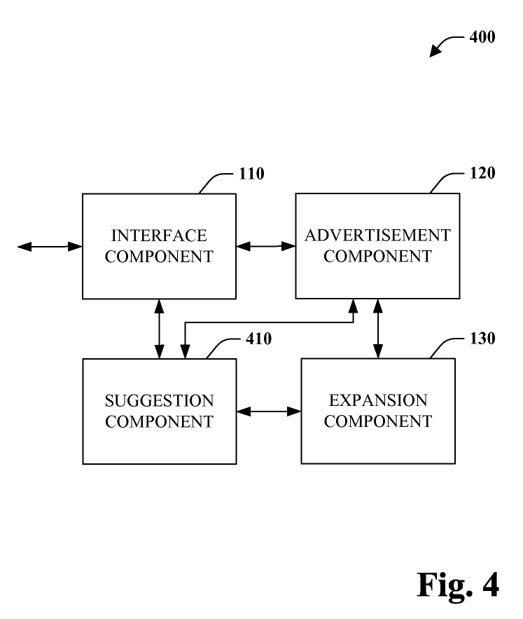

Turning to FIG. 4, a search system 400 is illustrated in accordance with an aspect of the disclosure. Similar to system 100 of FIG. 1, the system 400 includes the interface component 110, advertisement component 120 and expansion component 130, as previously described. In brief, the interface component 110 can receive input such as simplified expressions and return advertisements identified by the advertisement component 120. The expansion component 130 is employed by the advertisement component 120 to provide a candidate list of query expansions which can be utilized to match bid terms and/or phrases a facilitate content selection. In addition, the system 400 includes suggestion component 410 communicatively coupled to the interface component 110 and the expansion component 130.

The suggestion component 410 is a mechanism for identifying the top-k input expansions. When an input is provided in a simplified format, it is likely that a plurality of terms or expressions will match the input. At the same time, the input was likely specified to capture some particular term or phrase. For example, where a users enter a simplified query that utilized implicit or explicit wildcards they have some term and/or phrase in mind, namely an expanded query expression. The suggestion component 410 receives input and provides the data to the expansion component 130, identifies the top-k expansions and provides them back to a requesting entity via the interface component 110. The analysis performed by the suggestion component 410 can consider input by a user such as demographic information, history, statistics regarding the most popular expansions over a set of users and/or other context information, among other things. For example, based on previous history and the time of day, it can be determined that the top two expansions for “pi*” are “pizza” and “pies.”

Additionally, the suggestion component 410 can be utilized to dynamically update suggestions upon input entry. For example, suggested wildcard completions can be shown dynamically with suggestions changing and/or improving as each new character is input. In such a case, a user need not perform some action to obtain the suggested expansions. For instance, a user can input “S” and the suggestion component 410 and/or the expansion component 130 can provide “Shopping” as part of the candidate list. Subsequently, the user can input a space followed by an “N,” and the suggestion component 410 can modify the candidate list of suggestions such that “Shopping” is no longer included, but rather “Space Needle” is presented.

Similarly, the advertisement component 120 can receive input from one or both of the suggestion component 410 and the expansion component 130 and dynamically supply advertisement content as an input is received. For example, as a user enters a simplified query, the advertisement component 120 and the expansion component 130 can cooperate to facilitate affording relevant content in substantially real-time. In furtherance of this end, the advertisement component 120 can consider work performed by the suggestion component 410 regarding the top-k expansions. Further yet, it should be appreciated that entities may require content to appear when the top-k suggested expansions do not match their bid terms. In this instance, input from the suggestion component 410 would likely be required.

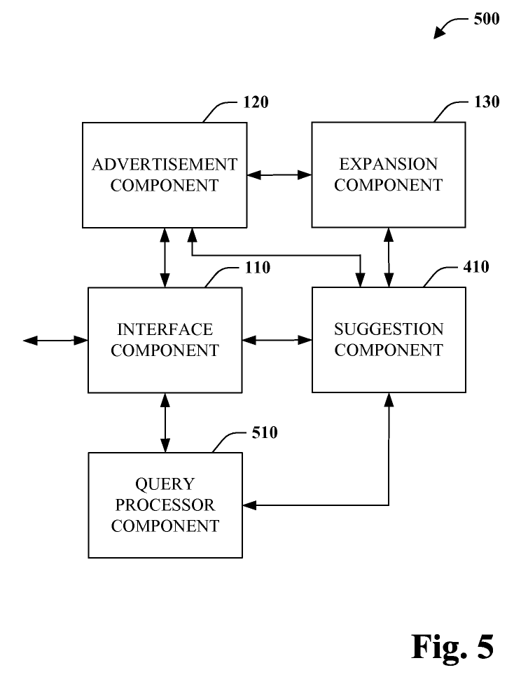

FIG. 5 depicts a search system 500 in accordance with an aspect of the disclosure. Similar to system 400 of FIG. 4, the system 500 includes the interface component 110, the advertisement component 120, the expansion component 130 and the suggestion component 410. As previously described, the aforementioned components can collaborate to provide suggested expansions and advertisements associated with a received input, such as a simplified expression. The system 500 also includes a query component 510 communicatively coupled to the interface component 110 and the suggestion component 410. Based on received input from one or both communicatively coupled components, the query component 510 can return results that match the input from a data domain (e.g., web, intranet, local computer, database . . . ). Where traditional fully expanded input query is provided, the query component 510 can evaluate the query over a data domain and return results via the interface component 110. If a simplified query employing wildcards is received, the query component 510 can obtain the top suggested expansion from the suggestion component 410 and return results based on evaluation of that expansion.

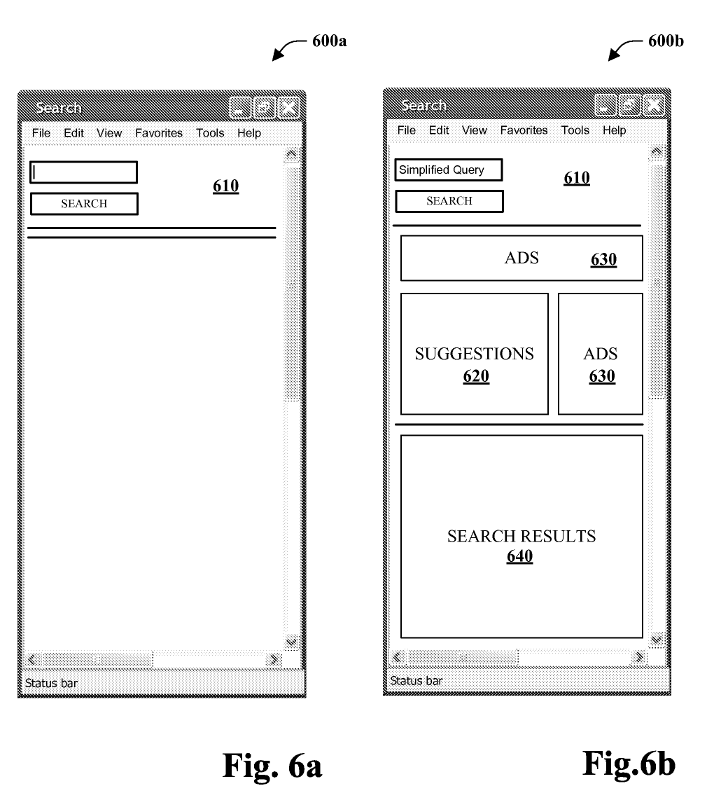

FIGS. 6a-b provide exemplary screenshots 600a and 600b illustrating an embodiment of aspects of the disclosure. Screenshot 600a shows a graphical user interfaces (GUI) with one main input portion 610. As illustrated, the portion 610 includes a text box for receiving input and a search button for initiating a search. Screenshot 600b depicts a graphical user interface after a search in initiated either manually by selecting the search button or automatically upon input. Again, the input portion 610 is shown this time with a simplified query as input. Suggested expansions are provided at 620 and surrounded above and beside by advertisement groups 630. Furthermore, query search results 640 are illustrated below the suggestions 620 and advertisements 630. The results 640 can be associated with the most popular expansion.

By way of example, entry of a simplified query in of the form “D* pizza” in the text box of input portion 610 and selection of the button can initiate return of results. Alternatively, the results can be returned and change automatically as input is entered. The suggestion portion 620 can include likely intended expansions such as “dominos pizza,” “domino's pizza,” “domino pizza” and “donatos pizza,” (Donatos®) and the advertisement groupings 630 can include links to websites related to pizza and more particularly dominos and/or donatos pizza. Further yet, the search results can provide links to web pages relevant to the best suggestion, here “dominos pizza.” Of course, selection of one of the other suggestions such as “donatos pizza” would cause the advertisements 630 and search results 640 to change to reflect the selection.

It is to be noted that the exemplary screenshots 6a-b are not the sole mechanism in which the interface component 110 of FIG. 1 can facilitate information exchange. Various other mechanisms can also be employed based at least in part on a communication medium utilized, all of which are to be deemed with in the scope of the subject claims.

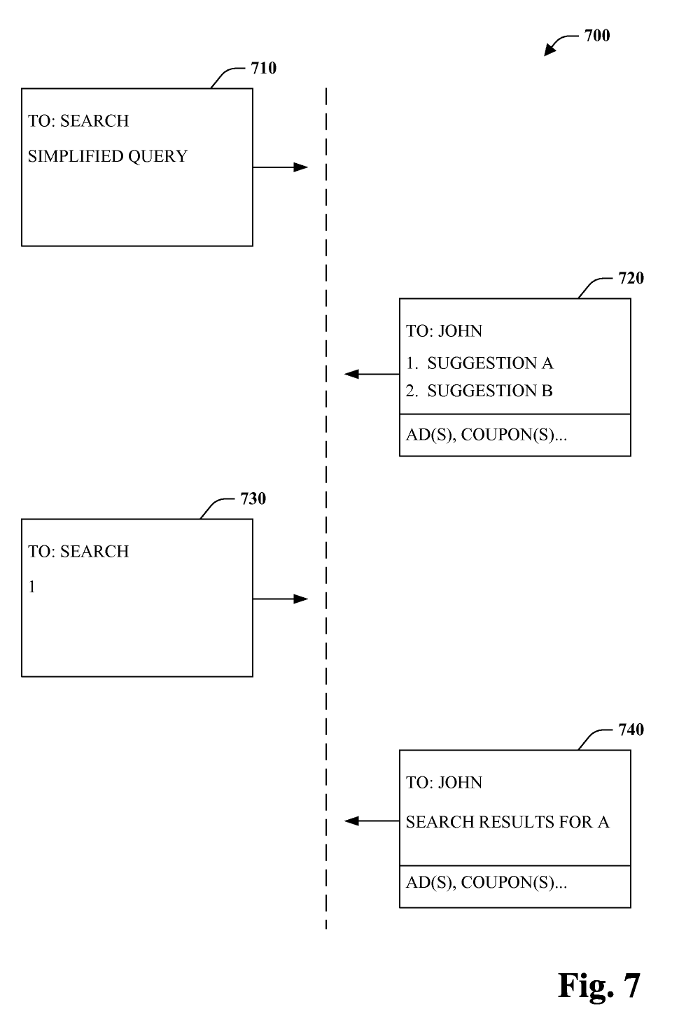

By way of example and not limitation, text messages can be exchanged over a SMS (Short Message Service) system. Turning attention to FIG. 7, a series of exchanged text messages 710-740 are illustrated to provide clarity and understanding with respect to this aspect. First, a user can send a text message 710 to a search application or service including a simplified query, such as a numeric implicit wildcard expression “6 9 2,” where “6” represents the letters “M,” “N” and “O” “9” represents “W,” “X” and “Y” and “2” represents “A,” “B” and “C.” In return, the user can receive a text message 720 providing one or more suggestions as well as some advertisements, coupons, phone numbers or the like. In the example, the suggestion can correspond to “New York City” and “National Weather Center” and advertisements may relate to one or both of the suggestions. A user can then identify the suggested expansion they desire in another text message 730 and information can be provided for the selected expansion as well as one or more advertisements, coupons or the like in a subsequent message 740.

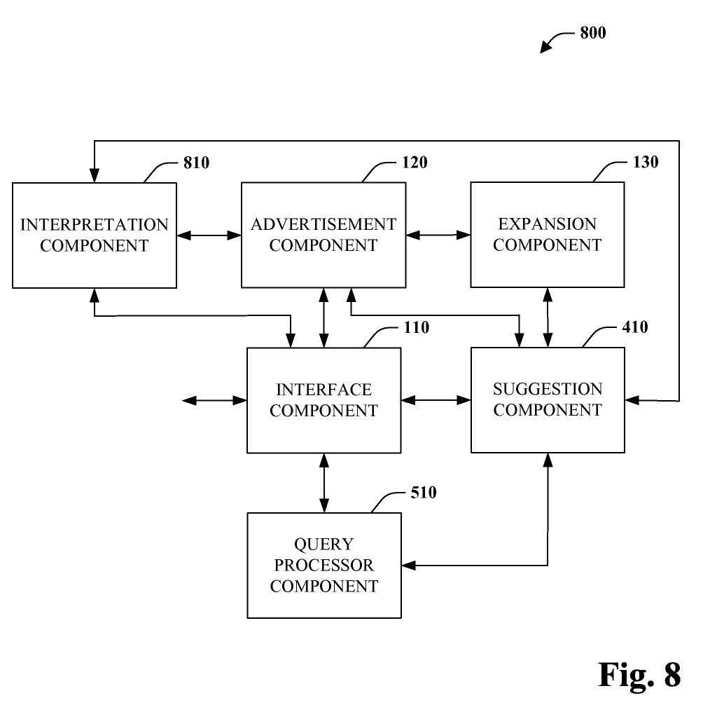

Referring to FIG. 8, a search system 800 is illustrated in accordance with an aspect of the disclosure. Similar to system 500 of FIG. 5, system 800 includes the interface component 110, advertisement component 120, expansion component 130, suggestion component 410 and query processor component 510, as previously described. Furthermore, system 800 includes interpretation component 810 communicatively coupled to the interface component 110, advertisement component 120 and suggestion component 410. The interpretation component 810 interprets an entered query and generates a recommendation. In one embodiment, component 810 can provide spelling correction and/or “Did you mean” type recommendation comparable to conventional mechanisms. Furthermore, the interpretation component 810 can receive or retrieve biding information from the advertisement component 120 to influence or bias results. For example, where a query has two equally likely spelling corrections one can be promoted over the other as a function of bids. Additionally or alternatively, the interpretation component 710 can interact with the advertisement component 120, expansion component 130 and/or suggestion component 410 to provide additional monetization opportunities. For example, where the interpretation component 710 identifies a particular query correction advertisements associated with alternate expansions and/or corrections can be provided in a sponsored link/advertisement section.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. For instance, the bid component 210 and store 220 of FIG. 2 can be external to the advertisement component 120. Further yet, one or more components and/or sub-components may be combined into a single component to provide aggregate functionality. For example, the expansion component 130 could include the suggestion component 410 of FIG. 4 or the functionality thereof. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the expansion component 120 and/or the suggestion component 410 can employ such mechanism to infer or predict expansions likely intended based on user demographics, historical interaction and/or other context information.

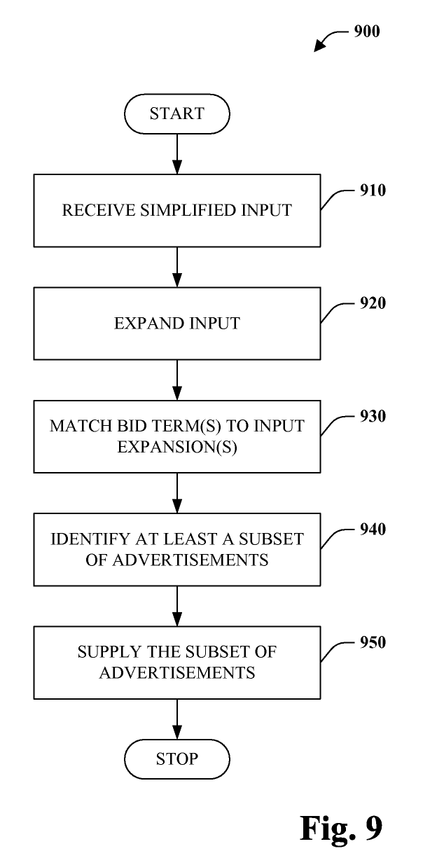

In view of the exemplary systems described sura, methodologies that may be implemented in accordance with the disclosed subject matter will be better appreciated with reference to the flow charts of FIGS. 9-12. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 9, an advertising method 900 is illustrated in accordance with an aspect of the disclosure. At reference numeral 910, a simplified input is received. As previously described, such input can be any short hand notation such as expressions with implicit and/or explicit wildcards that can be expanded. At numeral 920, the simplified input is expanded. For example, simplified input such a “Cinc Ohio,” “Cinc*i Ohio,” “Cin* O*” or “246* 64” can be expanded to “Cincinnati Ohio.”

Bid terms and/or phrases are matched to one or more input expansions at numeral 930. For “Cincinnati Ohio,” this can comprise identifying bid terms and/or phrases that match “Cincinnati,” “Ohio” or “Cincinnati Ohio.” At reference numeral 940, at least a subset of advertisements associated with matching bid terms and/or phrases is selected. The subset can seek to optimize revenue in light of matching criteria, performance measures and/or agreements with advertisers or other content entities. In one instance, this subset can be the top-k advertisements, where k is an integer greater than or equal to one. For example, the subset can be selected and/or ordered by a combination of one or more of bid amount and performance measure such as CTR, CPM or the like. In one scenario, such performance measures can be computed as a function of user demographics, the ad/item in question and the input. Still further yet, the value of a bid can be a function of the extent of an expansion, for example relating to a type and/or number of characters needed to be added to the simplified input to match the bid term and/or phrase.

At 950, the subset of advertisements or other content is provided or otherwise output. For instance, these cans can be caused to display in web browser and/or text message. It should be appreciated that the method 900 can be executed in substantially real-time to provide advertisements as a query is entered character by character in a web browser, for example.

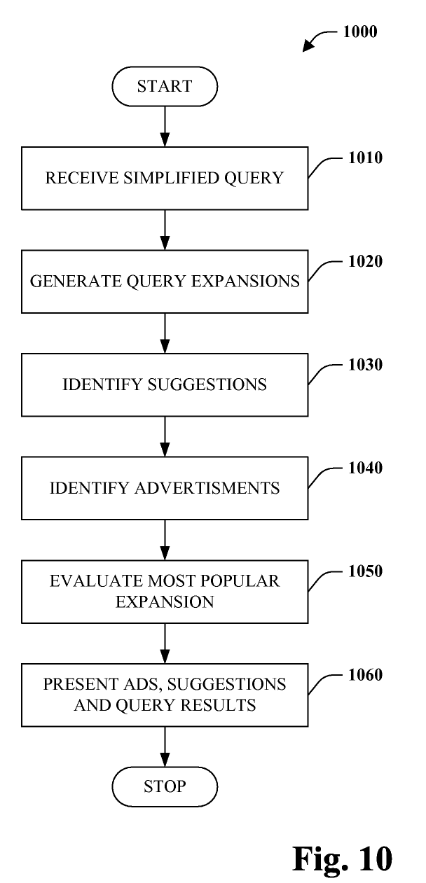

FIG. 10 is a flow chart diagram depicting a search method 1000 incorporating advertisements. At reference numeral 1010, a simplified query or query expression is received such as but not limited to implicit and/or explicit wildcard expressions. The simplified query is subsequently expanded to generate one or more query expansions at 1020. From the generated query expansions a select few (e.g., top-k) are chosen as suggestions, for instance based on a plurality of contextual information at 1030. At reference 1040, one or more advertisements or other content items are identified based on either or both of the generated expansions and suggestions. For example, an entity may specify a bid indicating that they would like their content presented where bid terms and/or phrases match one or more expansions and a matching expansion is either included or excluded as a suggestion. The highest priority or most popular expansion or suggestion is evaluated at 1050. At reference numeral 1060, one or more suggestions and/or advertisements are presented together with search results from the most likely expansion.

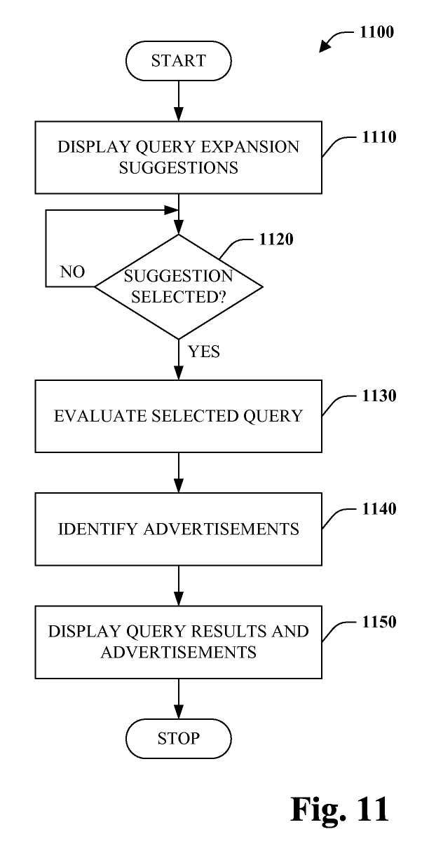

FIG. 11 illustrates a search method 1100 based on query expansions in accordance with an aspect of the subject disclosure. At reference numeral 1110, a plurality of query expansion suggestions are displayed alone or in combination with advertisements or other sponsored content. A determination as to whether a suggestion has been selected made at numeral 1120. If no, the method 1100 can continue to loop until one is selected. Once a suggestion is selected, the selected query expansion is evaluated at 1130. Advertisements or other content can be identified at 1140. Such content can be identified based on matching bid terms and/or phrases with the selected query expansion, among other things. At reference numeral 1150, one or more query results and/or advertisements are displayed or packaged for display. The method 1100 can optionally present suggestions and loop back to 1120 such that an alternative suggestion can be selected and the display updated to present results based thereon.

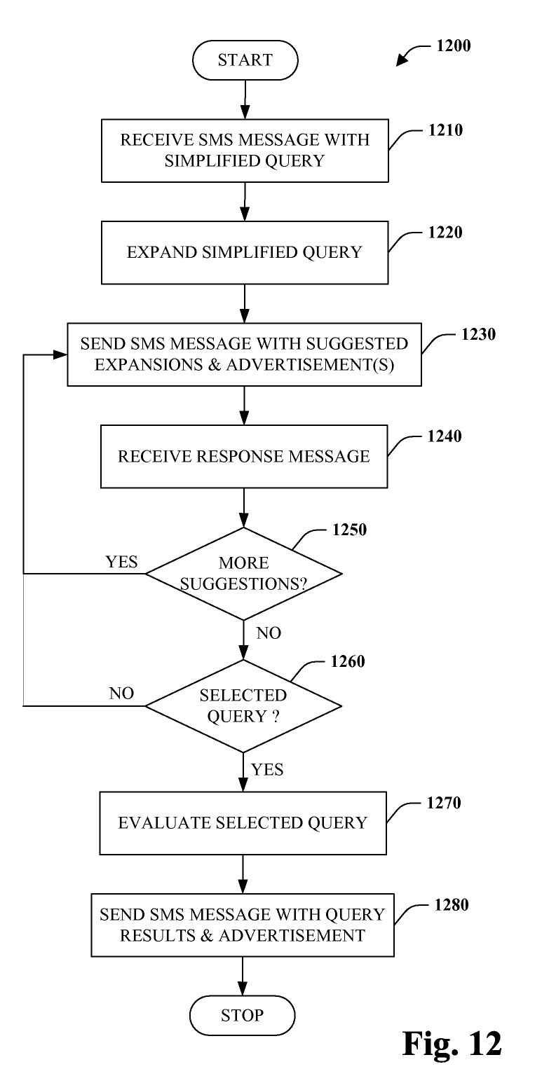

Referring to FIG. 12, a method 1200 of processing short message service (SMS) messages including queries is depicted according to an aspect of the disclosure. While queries are typically presented though a web browser or other graphical interface, they may be provided by way of alternate technology including an SMS system. At reference numeral 1210, an SMS message with a simplified query is received. For example, the message can include an implicit and/or explicit wildcard expression alone or in combination with other terms. The simplified query is expanded at reference 1220 producing one or more valid query expansions. At numeral 1230, an SMS is sent responding to the initial message including the top-k suggestions as well as some sponsored content identified based at least in part on bids and the query expansions. A response message is received at 1240. The message is then analyzed. At numeral 1250, a determination is made as to whether the message includes a request for additional suggestions. If it does, then the method 1200 can proceed to 1230 where the next top-k expansions are sent along with one or more advertisements. If a request for additional suggestions is not included, then a determination is made as to whether a suggestion or suggested expansion has been selected at reference 1260. If no, the method 1200 can proceed to 1230 where suggestions are resent or alternatively simply terminate. However, if a suggestion has been selected then at 1270 the selected query expansion is evaluated. Query evaluation results as well as associated advertisements can subsequently be sent via SMS to the requesting entity at reference numeral 1280.

As used herein, the terms “component,” “system,” “service” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

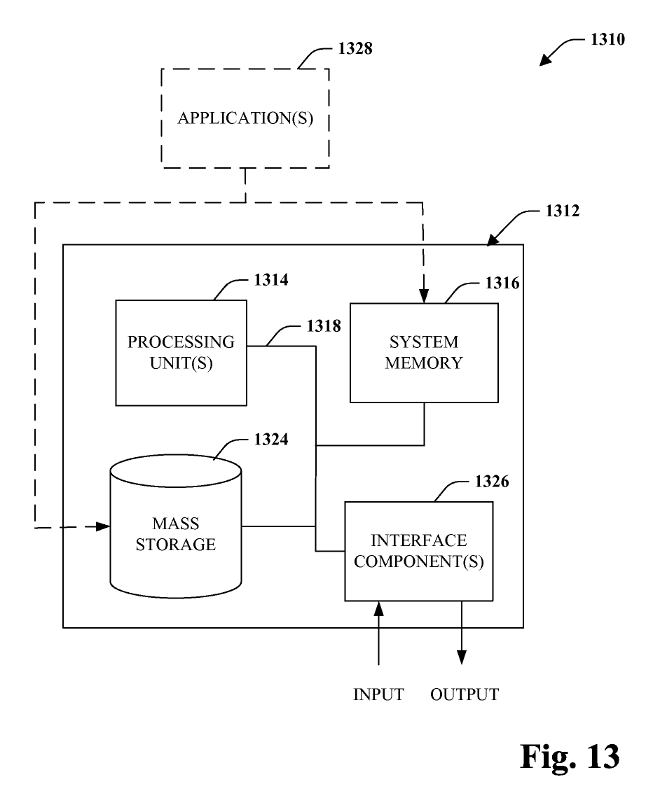

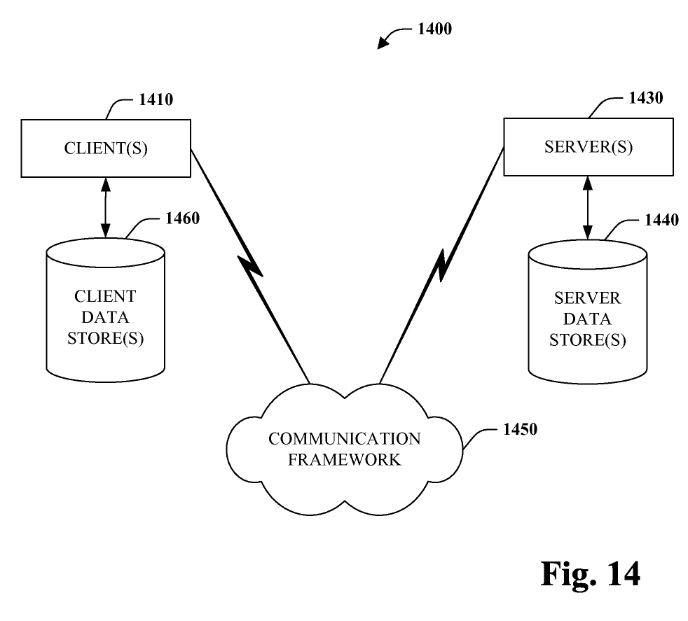

In order to provide a context for the various aspects of the disclosed subject matter, FIGS. 13 and 14 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 13, an exemplary environment 1310 for implementing various aspects disclosed herein includes a computer 1312 (e.g., desktop, laptop, server, hand held, programmable consumer or industrial electronics . . . ). The computer 1312 includes a processing unit 1314, a system memory 1316 and a system bus 1318. The system bus 1318 couples system components including, but not limited to, the system memory 1316 to the processing unit 1314. The processing unit 1314 can be any of various available microprocessors. It is to be appreciated that dual microprocessors, multi-core and other multiprocessor architectures can be employed as the processing unit 1314.

The system memory 1316 includes volatile and nonvolatile memory. The basic input/output system (BIOS), containing the basic routines to transfer information between elements within the computer 1312, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1312 also includes removable/non-removable, volatile/non-volatile computer storage media. FIG. 13 illustrates, for example, mass storage 1324. Mass storage 1324 includes, but is not limited to, devices like a magnetic or optical disk drive, floppy disk drive, flash memory or memory stick. In addition, mass storage 1324 can include storage media separately or in combination with other storage media.

FIG. 13 provides software application(s) 1328 that act as an intermediary between users and/or other computers and the basic computer resources described in suitable operating environment 13 10. Such software application(s) 1328 include one or both of system and application software. System software can include an operating system, which can be stored on mass storage 1324, that acts to control and allocate resources of the computer system 1312. Application software takes advantage of the management of resources by system software through program modules and data stored on either or both of system memory 1316 and mass storage 1324.

The computer 1312 also includes one or more interface components 1326 that are communicatively coupled to the bus 1318 and facilitate interaction with the computer 1312. By way of example, the interface component 1326 can be a port (e.g., serial, parallel, PCMCIA, USB, FireWire . . . ) or an interface card (e.g., sound, video, network . . . ) or the like. The interface component 1326 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1312 to output device(s) via interface component 1326. Output devices can include displays (e.g., CRT, LCD, plasma . . . ), speakers, printers and other computers, among other things.

FIG. 14 is a schematic block diagram of a sample-computing environment 1400 with which the subject innovation can interact. The system 1400 includes one or more client(s) 1410. The client(s) 1410 can be hardware and/or software (e.g., threads, processes, computing devices). The system 1400 also includes one or more server(s) 1430. Thus, system 1400 can correspond to a two-tier client server model or a multi-tier model (e.g., client, middle tier server, data server), amongst other models. The server(s) 1430 can also be hardware and/or software (e.g., threads, processes, computing devices). The servers 1430 can house threads to perform transformations by employing the aspects of the subject innovation, for example. One possible communication between a client 1410 and a server 1430 may be in the form of a data packet transmitted between two or more computer processes.

The system 1400 includes a communication framework 1450 that can be employed to facilitate communications between the client(s) 1410 and the server(s) 1430. Here, client(s) 1410 can refer to simplified query providers and the server(s) can provide the query processing mechanism. The client(s) 1410 are operatively connected to one or more client data store(s) 1460 that can be employed to store information local to the client(s) 1410. Similarly, the server(s) 1430 are operatively connected to one or more server data store(s) 1440 that can be employed to store information local to the servers 1430. In one instance, the client(s) 1410 can be employed by a user to specify and transit a simplified query over the communication framework 1450 to server(s) 1430 for processing. The server(s) 1430 can provide query results, suggestions and/or advertisements back to the client(s) 1410. Moreover, it is to be appreciated that functionality/computation can be distributed in a myriad of ways across client(s) 1410 and server(s) 1430. For example, a client application or plug-in could generate query expansions and provide then to the server(s) 1430 for processing.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A search advertisement system, comprising:
an interface component that receives a simplified query; and
an advertisement component that identifies at least one advertisement associated with one or more bid terms that match an expansion of the simplified query.

2. The system of claim 1, the interface component displays the at least one advertisement.

3. The system of claim 1, further comprising an expansion component that expands the simplified query.

4. The system of claim 3, further comprising a suggestion component that identifies a subset of expanded queries most likely intended.

5. The system of claim, 4 the interface component displays the subset of expanded queries.

6. The system of claim 5, the interface component displays the at least one advertisement associated with the one or more bid terms where the one or more bid terms are not included within the displayed subset of expanded queries.

7. The system of claim 4, further comprising a query processor component that evaluates at least one of the expanded queries.

8. The system of claim 7, the interface component displays results of expanded query evaluation.

9. The system of claim 1, the simplified query is at least one of an implicit and/or explicit wildcard expression.

10. The system of claim 1, the interface component serves the at least one advertisement to a short message service (SMS) system.

11. A computer-implemented method of advertisement, comprising:
generating one or more query expansions from a simplified query; and
matching one or more bid terms to the one or more query expansions.

12. The method of claim 11, further comprising identifying one or more advertisements associated with at least a subset of the one or more matching bid terms based on value of the matching terms.

13. The method of claim 12, further comprising determining the value of the matching bid terms based on a bid amount and a performance measure.

14. The method of claim 12, further comprising determining the value of the matching bid terms based on demographic information.

15. The method of claim 12, further comprising scaling the value of the one or more matching bid terms as a function of degree of difference between the simplified query and the matching query expansion.

16. The method of claim 12, further comprising displaying the one or more identified advertisements.

17. The method of claim 11, further comprising identifying matching bid terms that satisfy demographic requirements.

18. The method of claim 11, further comprising receiving bids on terms as a function of at least one of click through, impression, call, revenue and/or user action.

19. The method of claim 11, further comprising receiving bids on one or more terms that match query expansions outside top-k expansions suggested.
